(19) United States
(12) Patent Application Publication
(10) Pub. No.: US 2022/0241628 A1
(43) Pub. Date: Aug. 4, 2022

(54) METHODS AND APPARATUSES FOR MITIGATING FIRE RISK

(71) Applicant: Benjamin Sofer, La Mesa, CA (US)

(72) Inventor: Benjamin Sofer, La Mesa, CA (US)

(21) Appl. No.: 17/645,958

(22) Filed: Dec. 23, 2021

Related U.S. Application Data
(60) Provisional application No. 63/145,218, filed on Feb. 3, 2021.

(51) Int. Cl. A62C 3/02; A62C 35/58

(52) U.S. Cl. CPC A62C 3/0214; A62C 35/58

(57) ABSTRACT

An apparatus for mitigating the risk of fire to a structure includes a drain fluidly coupled to a volume of water and at least one soaker component configured to dispense water to soak at least a portion of the structure. The apparatus also includes at least one connection point configured to connect to an external fire mitigation device and a diverter valve selectively operable in a first position and in a second position, wherein the first position fluidly connects the drain to the at least one soaker component and the second position fluidly connects the drain to the at least one connection point. The apparatus also includes a pump fluidly connected between the drain and the diverter valve and configured to move water from the drain to one of the at least one soaker component and the at least one connection point.

### PRIORITY

This application claims the benefit of priority to co-owned U.S. Provisional Patent Application No. 63/145,218 entitled “METHODS AND APPARATUSES FOR MITIGATING FIRE RISK” filed Feb. 3, 2021, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present disclosure relates to methods and apparatuses for mitigating fire risk. More particularly, the present disclosure relates to methods and apparatuses for mitigating fire risk by dispensing water from pools.

### DESCRIPTION OF RELATED TECHNOLOGY

This section provides background information related to the present disclosure which is not necessarily prior art.

The risk of wildfires has become increasingly important in light of the increased scope of damage that wildfires can cause to residences and other buildings. Current methods and apparatuses for fighting, mitigating and/or extinguishing wildfires have many disadvantages. First, water is often used to mitigate wildfires but water can be a scarce resource in many areas that are affected by wildfires. In addition, existing methods and apparatuses often require intervention by professional firefighting personnel and/or specialized firefighting equipment. Individual homeowners or property owners are often left without a means to combat wildfires without the assistance of such professional firefighters or their specialized equipment. Furthermore, professional firefighters and the specialized equipment are often insufficient to meet the needs of all homeowners and property owners when there are active wildfires. Therefore, there exists a need for improved methods and apparatuses for mitigating the risk to property and structures caused when active wildfires are present.

### SUMMARY

This section provides a general summary of the disclosure and is not a comprehensive disclosure of its full scope or all of its features.

In some embodiments, an apparatus for mitigating the risk of and actively fighting fire is provided. In some embodiments, methods of installation, use, manufacture of a mitigation apparatus is disclosed.

In one embodiment, the apparatus is configured to mitigate the risk of fire to a structure. The apparatus can include a drain fluidly coupled to a volume of water and at least one soaker component configured to dispense water to soak at least a portion of the structure. The apparatus can also include at least one connection point configured to connect to an external fire mitigation device and a diverter valve selectively operable in a first position and in a second position, wherein the first position fluidly connects the drain to the at least one soaker component and the second position fluidly connects the drain to the at least one connection point. The apparatus can also include a pump fluidly connected between the drain and the diverter valve and configured to move water from the drain to one of the at least one soaker component and the at least one connection point.

In one aspect, the apparatus can include a plurality of soaker components arranged in a predetermined pattern to soak a predetermined portion of the structure.

In another aspect, the drain can be positioned in a base of a swimming pool.

In another aspect, the pump and diverter valve can operate independently of a filtering system of the swimming pool.

In another aspect, the at least one soaker component can include an extension conduit and a sprinkler wherein the sprinkler includes a heat-activated actuator.

In another aspect, the at least one connection point can include a fitting configured to couple to a fire hose.

In another aspect, the diverter valve can include a selector handle wherein the selector handle is configured to move the diverter from the first position to the second position.

In another aspect, the apparatus can include a check valve fluidly connected between the drain and the pump.

In another aspect, the apparatus can include a protection soaker fluidly connected to the pump and configured to dispense water onto at least one of the pump and the diverter valve.

In another aspect, the apparatus can include a mitigation controller operatively connected to the pump to selectively change the pump from a dormant state to an active state.

In another aspect, the apparatus can include a housing substantially enclosing the pump, the diverter valve and the mitigation controller.

In another aspect, the apparatus can include the mitigation controller is connected to a communication network to allow the pump to be selectively changed from the dormant state to the active state from a location remote from the mitigation controller.

In another aspect, the pump is operatively connected to a back-up power source.

In another aspect, the structure is a residential home.

In some embodiments of the present disclosure, a method of mitigating the risk of fire to a structure is provided. The method can include activating a pump to move water from a volume of water to a diverter valve and selecting between a soaking mode and a firefighting mode by selecting a first position or a second position on the diverter valve. The method can also include dispensing water to at least one soaker component when the soaking mode is selected or dispensing water to at least one connection point when the firefighting mode is selected.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments, not all possible implementations, and are not intended to limit the scope of the present disclosure.

FIG. 1 is a block diagram illustrating an example fire risk mitigation apparatus of the present disclosure.

FIG. 2 is a cut-away side view illustrating aspects of the fire risk mitigation apparatus of FIG. 1.

FIG. 3 is a side view illustrating further aspects of the fire risk mitigation apparatus of FIG. 1.

FIG. 4 is a perspective view illustrating an example fire risk mitigation apparatus relative to a swimming pool and a filtering system.

FIG. 5 is a side view of an example diverter valve and soaking extension used in a fire risk mitigation apparatus of the present disclosure.

Corresponding reference numerals indicate corresponding parts throughout the several views of the drawings.

### DETAILED DESCRIPTION

Example embodiments will now be described more fully with reference to the accompanying drawings. For purposes of the description hereinafter, it is to be understood that the embodiments described below may assume alternative variations and embodiments. It is also to be understood that the specific articles, compositions, and/or processes described herein are exemplary and should not be considered as limiting. In the description, relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

### Exemplary Apparatus for Mitigating the Risk of Fire

Wildfires as well as other fires that can spread between neighboring structures or other neighboring materials can be difficult to prevent and/or mitigate. Existing methods and apparatuses that are used to mitigate the risk of a fire to structure often include professional personnel such as firefighters and specialized equipment such as fire engines, helicopters, and the like. Such equipment and professional firefighters can be inadequate to mitigate the spread of fires in circumstances that can include large wildfires or other fires that can threaten the safety and property of many individuals.

The methods and apparatuses of the present disclosure can be installed and used at individual structures to make use of existing water sources to mitigate the risk of fire. The methods and apparatuses of the present disclosure can operate without the need for specialized training or the involvement of professional firefighters. The methods and apparatuses of the present disclosure can operate automatically when a wildfire is detected or upon activation by a user. The methods and apparatuses of the present disclosure can be used in connection with any structure in which a local volume of water is available to be dispensed to mitigate the risk of fire. Example structures include residences, homes, apartment buildings, office buildings, warehouses, factories, condominium buildings, schools, and the like.

In some examples, the methods and apparatuses of the present disclosure can be installed and used in connection with a home or residence that may include a swimming pool located adjacent to or near to the residence. It is often the case that wildfires can spread and destroy residences and the swimming pool that is located next to the residence remains full of water after the residence has been destroyed. The methods and apparatuses of the present disclosure can make use of the water in the swimming pool as a valuable resource to mitigate the risk of fire damage to the neighboring residence. It should be appreciated that aspects of the present disclosure can be incorporated into new construction of residential homes and neighborhoods. It should also be appreciated, however, that aspects of the present disclosure can also be applied to other structures and to other volumes of water that may be located adjacent to or local to the structure. For the sake of brevity, however, many of the examples described below describe the methods and apparatuses of the present disclosure in the context of a residence with an adjacent swimming pool.

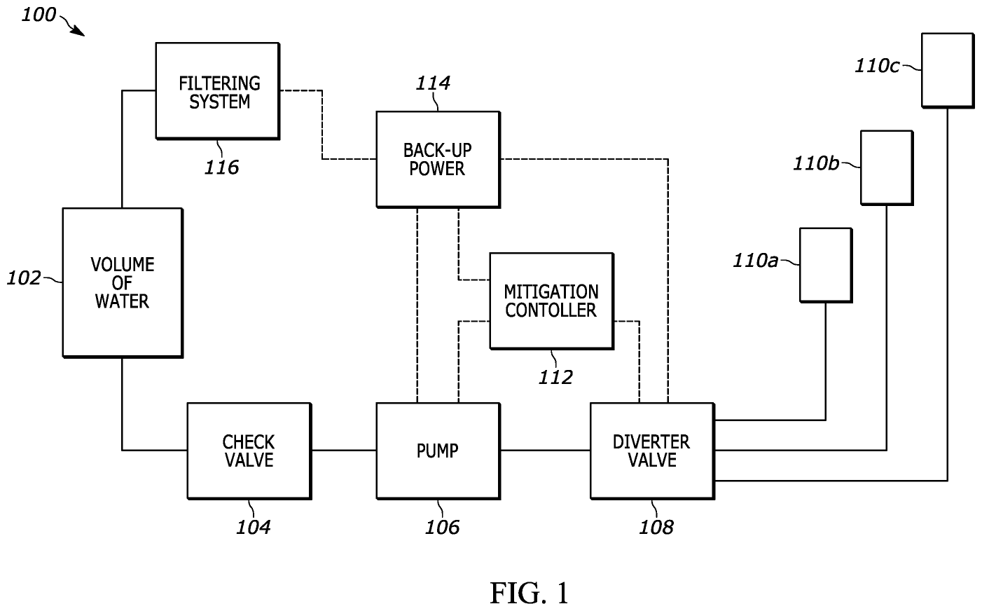

Referring now to FIG. 1, an example fire mitigation apparatus 100 is shown. The example fire mitigation apparatus 100 can include a volume of water 102, a check valve 104, a pump 106, a diverter valve 108, and one or more soaker components 110. As will be further described below, the check valve 104 can be fluidly connected to the volume of water 102. Any suitable conduits can be used to connect the elements of the fire mitigation apparatus 100 that are described as being fluidly connected. Such conduits can include pipes, tubing or other conduits that can allow water (or other fluid) to move between the fluidly connected elements.

As further shown, the pump 106 can be fluidly connected between the check valve 104 and the diverter valve 108. The check valve 104 can be any suitable check valve that can prevent the movement of fluid away from the pump 106 and toward the volume of water 102. For example, a swing check valve, a stop-check valve, a ball check valve or a silent check valve or the like can be used. The check valve 104 can assist in maintaining a quantity of fluid in the pump 106 such that the pump 106 is primed and ready for operation when it is activated.

The pump 106 can be any suitable fluid pump such as a positive displacement or a centrifugal pump. In other examples, other types of pumps can also be used. The pump 106 can be a single-speed, a two-speed or variable speed pump. The pump 106 can operate to move fluid from the volume of water 102 through the diverter valve and to the soaker components no. Any suitable pump can be used in order to move sufficient quantities of fluid to the soaker components no in order to sufficiently mitigate the risk of fire.

The fire mitigation apparatus 100 can also include the diverter valve 108. The diverter valve 108 can be positioned downstream of the pump 106 and can operate to divert or guide water to a desired soaker component or other connection point as will be described further below. The diverter valve 108 can operate manually or automatically to divert fluid to a desired dispensing mechanism. Any suitable diverter valve 108 can be used such as a 3-way valve or other multi-port valve. The diverter valve 108 can be manually operated by a suitable selector handle or can have a solenoid, pneumatic or other electrically operated actuator. The diverter valve 108 can operate to dispense water to one or more of the soaker components 110, for example.

The soaker components 110 can be fluidly connected downstream of the diverter valve 108. The soaker components 110 can be any suitable sprinkler, connector, dispenser, nozzle, opening or the like that can dispense water (or other fluid) to a desired location. The soaker components 110 can, for example, include a length of conduit that positions a sprinkler head at a desired location on a structure. The pump 106, when activated, can move water (or other fluid) to one or more of the soaker components 110, as determined by diverter valve 108, to dispense the water (or other fluid) at the desired location to mitigate the risk of fire.

As further shown, the fire mitigation apparatus 100 can also include a mitigation controller 112. The mitigation controller 112 can be any suitable controller such as a micro-controller, programmable logic controller (PLC), or other computing or processing device that can control the operation of one or more elements of the fire mitigation apparatus 100. The mitigation controller 112 can be coupled to a wired or wireless communication network (not shown) that can allow the mitigation controller to send and/or receive signals from the elements of the fire mitigation apparatus 100 and/or from a user device such as a tablet, smart phone, laptop, voice assistant or other personal computing device. For example, the mitigation controller 112 may include a network interface that may receive data from and transmit data to a network such as the internet via a cellular, local-area network or wide-area network to allow a user to control the operation of the pump 106, the diverter valve 108, and/or one or more of the soaker components no from a location remote from the mitigation controller 112. Furthermore, the mitigation controller 112 can also be coupled to sensors (not shown; e.g., heat sensor, ionization smoke detection sensor, and photoelectric smoke detection sensor, flame sensor, cameras, etc.) or to information sources (e.g., weather information sources, emergency management information sources, etc.) that can allow the mitigation controller 112 to automatically control the operation of the fire mitigation apparatus 100 in response to receiving or obtaining information about a risk of fire.

In other examples, the mitigation controller 112 can be physically or directly coupled to the pump 106 and/or the diverter valve 108. The mitigation controller 112 can also include suitable user input devices such as buttons, dials, touchscreens, switches or the like to allow a user to operate and control the fire mitigation apparatus 100.

As further depicted in FIG. 1, the fire mitigation apparatus 100 can include a back-up power source 114. While not shown in FIG. 1, the pump 106, the mitigation controller 112 and/or the diverter valve 108 can be coupled to suitable primary power source such as an existing electrical system that is typically provided to residences and other structures. The back-up power source 114 can also be coupled to the pump 106, the mitigation controller 112 and/or the diverter valve 108 and can be used to power these elements when the primary power source has been disrupted or disconnected. The back-up power source 114 can be a battery, generator, solar array, wind turbine or other suitable power source that can be operated independently of the primary power source.

The fire mitigation apparatus 100 can be an independent system that can be operated independently of or separate from other systems that may be connected to the volume of water 102. In some instances, the volume of water 102 can be a swimming pool that traditionally includes a filtering system 116. The fire mitigation apparatus 100 can be operated independently of and separately from the filtering system 116. In some examples, the swimming pool may have an auto-fill setting when the volume of water inside the swimming pools drops below a pre-determined level. Such setting may allow fire mitigation apparatus 100 to operate for a longer duration as the pool refills as fire mitigation apparatus 100 drains the swimming pool.

Additionally, simplified embodiments of fire mitigation apparatus 100 may provide similar utility as would be understood by those of ordinary skill. In one embodiment, fire mitigation apparatus 100 is connectable to volume of water 102, and includes check valve 104, pump 106, and is connectable to soaker components 110 without, e.g., diverter valve 108 and connection to an external fire mitigation device, e.g., a fire hose. In another embodiment, fire mitigation apparatus is connectable to volume of water 102, and includes check valve 104, pump 106, and an output port or interface to connect to an external fire mitigation device without, e.g., diverter valve 104 and connections to soaker components 110.

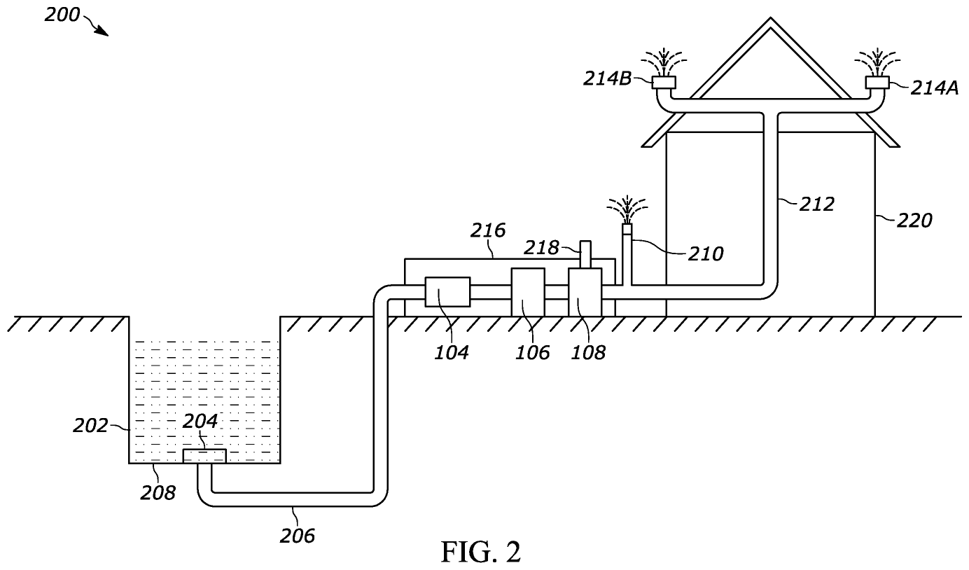

Referring now to FIG. 2, another example fire mitigation apparatus 200 is shown. In this example, the fire mitigation apparatus 200 can be fluidly connected to a swimming pool 202 that can be located adjacent to or proximate to a residential structure 220. In this example, the fire mitigation apparatus 200 is fluidly connected to the swimming pool 202 by a drain 204. The drain 204 can be any suitable drain such as a pool drain. An example drain that can be suitable for use in the fire mitigation apparatus 200 can include a ten inch round anti-vortex drain cover. The drain cover can include an area of at least 30 square inches and can allow a flow rate of at least 130 gallons per minute. Various embodiments of fire mitigation apparatus 100 may optimally run at a certain (minimum) water flow rate based on, e.g., the flow rate of pump 106 and/or the placement, number of, and/or water output of soaker components 110, 214. Suitable drain covers include a ten inch round drain cover manufactured by Waterway Plastics of Oxnard, Calif. In other examples other suitable drain covers can be used.

The drain 204 can be positioned at a base 208 of the swimming pool 202. The drain 204 can be a separately formed drain that is positioned in the swimming pool 202 in addition to any drains that may be used by a filtering system or other system for the swimming pool 202. An intake conduit 206 can be fluidly connected to the drain 204. In one example, a length of polyvinyl chloride (PVC) pipe with a 2½ inch diameter can be fluidly connected to the drain 204. In other examples, other types and sizes of piping or tubing can be used. The intake conduit can fluidly connect the drain 204 to the other elements of the fire mitigation apparatus 200.

In the example shown, the intake conduit 206 can be fluidly connected to the check valve 104. The check valve 104 can be any suitable check valve as previously described. In one example, the check valve 104 can be a 2 W inch diameter check valve manufactured by Jandy. The check valve 104 can be made of any suitable material such as metal, plastic or composite. The check valve 104 can include a removable cover to allow repair and/or maintenance of the check valve 104 to be easily performed.

The fire mitigation apparatus 100 can also include a pump 106. The pump 106 can be positioned downstream of the check valve 104 and can be fluidly connected to the check valve 104 by a length of conduit. Any suitable pump, as previously described, can be used. In one example, a self-priming 2 horsepower pump can be used. A suitable pump can be a self-priming 2 horsepower pump manufactured by Pentair Aquatic Systems. The pump 106 can be a centrifugal pump that can have the capacity to move water at a flow rate in excess of 160 gallons per minute. In other examples, other pumps can be used. In another example, pump 106 may include an automatic shutoff, with, e.g., a float switch or other suitable mechanism, configured to turn off power when the volume of water is exhausted.

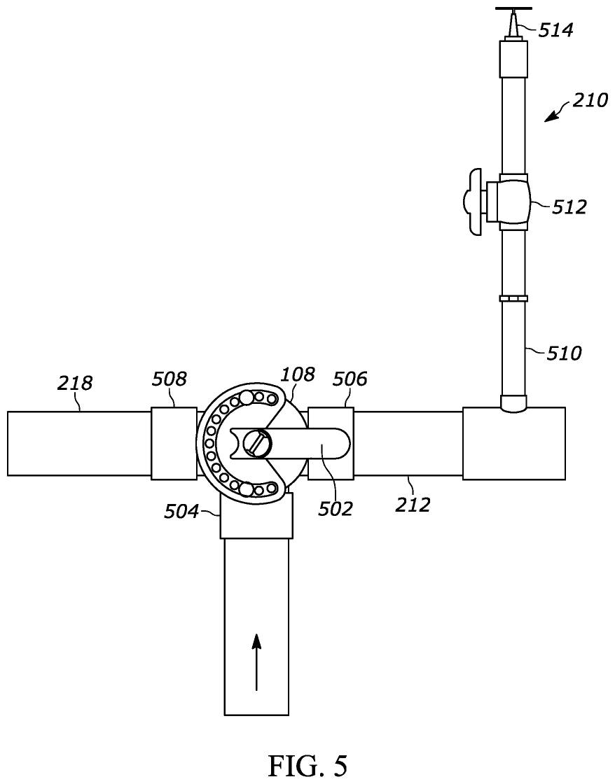

A diverter valve 108 can be fluidly connected to the pump 106. A length of conduit can be used to connect the diverter valve 108 downstream of the pump 106. As discussed, any suitable diverter valve can be used such as a suitable 3-way valve. In one example, the diverter can be a 3-way valve manufactured by Jandy. The 3-way valve can be a 2½ inch diameter or a 3 inch diameter valve. An example diverter valve 108 is shown in FIG. 5. As shown, the diverter valve 108 can include an input port 504 and a first output port 506 and a second output port 508. The conduit from the pump 106 can be fluidly connected to the input port 504 to convey water from the pump 106 to the diverter valve 108. The diverter valve 108 can operate in a first position in which an internal gate inside the diverter valve 108 guides water from the input port 504 to the first output port 506. The diverter valve 108 can also operate in a second position in which the internal gate in the side the diverter valve 108 can guide water from the input port 504 to the second output port 508. The diverter valve 108 can be selectively moved from the first position to the second position to cause the water to be guided through either the first output port 506 or the second output port 508 as desired. In the example shown in FIG. 5, the diverter valve 108 includes a selector handle 502. The selector handle 502 can be manually moved (or rotated) to change the diverter valve 108 from the first position to the second position and vice versa. In other examples, the diverter valve 108 can include other selector mechanisms to move the diverter valve 108 from the first position to the second position. Such other selector mechanisms can be manually operated by a user or can be automatically actuated using electronic, pneumatic, or other actuation methods.

The diverter valve 108 can be moved between the multiple positions to guide water to one of multiple dispensers. In the example shown in FIG. 2, the fire mitigation apparatus includes a connection point 218, and a plurality of dispensers that can include a protection soaker 210 and one or more soaker components 214. In one position (e.g., the first position as previously described), the diverter valve 108 can guide water to a conduit that is fluidly connected to the protection soaker 210 and to the soaker components 214. The protection soaker 210 can be positioned adjacent to or proximate to the check valve 104, the pump 106 and/or the diverter valve 108. The protection soaker can include a sprinkler head or other dispenser that can dispense water onto the check valve 104, the pump 106 and/or the diverter valve 108. In case of fire, the protection soaker 210 can dispense water onto the elements of the fire mitigation apparatus 100 to prevent damage to the fire mitigation apparatus 200 and to allow the fire mitigation apparatus 100 to continue to operate to mitigate the risk of fire to the structure 220.

Soaker components 214 may work optimally when receiving water that is free from debris above a certain size. Debris (e.g., sand, stones) or organic material (e.g., grass, leaves, algae, etc.), for example, may clog soaker components 214 and may alter the radius or shape/direction of the output stream of water passing through soaker components 214. A drain cover attached to drain 204 or a screen within pump 106 may filter out large debris, but the debris the drain cover or pump screen allows to pass may be larger than the requirements of soaker components 214. Fire mitigation apparatus 100 may include an inline filter (not shown) to filter water that will be guided to the one or more soaker components 214. As discussed, any suitable inline filter may be used. For example, the inline filter may include one or a combination of a disk filter, a media filter, a screen filter, and a centrifugal filter. The type of filter used may be based on the water pressure and flow rate requirements of soaker components 214 and the type and quality of water in the volume of water 102.

In some examples, the inline filter may be positioned upstream or downstream the check valve 104, the pump 106 and/or the diverter valve 108 and connectable via one or more lengths of conduit. Access to the inline filter may be made via a removable maintenance cover for maintenance. In some examples, the same maintenance cover is used to access the check valve 104. In another example, the inline filter is fluidly connected to diverter valve 108. In some examples, the inline filter is downstream of one output port (e.g., first output port 506) of diverter valve 108. This may be beneficial as the other output port (e.g., second output port 508) may be fluidly connected to an external fire mitigation device, e.g., a fire hose, that does not have the same debris requirements or risk of clogging as soaker components 214. In a further example, each or certain soaker components 214 may have a dedicated inline filter/screen. In another example, water from fire mitigation apparatus 100 may be diverted (using, e.g., valves) to a filter in filtering system 116 and diverted back to components of the fire mitigation apparatus 100.

In addition to guiding water to the protection soaker 210, the diverter valve 108 can cause water to be guided to the distribution conduit 212 that can distribute water to the one or more soaker components 214a and 214b. While the illustration of FIG. 2 shows two soaker components 214a and 214b, the fire mitigation apparatus 200 can include more soaker components. In some examples, the fire mitigation apparatus 200 can include three or more soaker components. In still other examples, the fire mitigation apparatus can include five or more soaker components. The number of soaker components can also be determined based on the size of the structure 220 that is being protected against the risk of fire. For example, each soaker component 214 can include a sprinkler head that has a predetermined water distribution radius. In some examples the distribution radius can be five feet. In such examples, the soaker components can be distributed in a pattern on the structure 220 so that the distribution radii of the soaker components overlap so a desired portion or substantially all of the exterior surface of the structure 220 is soaked with water during operation. One or more soaker components 214a and 214b may be placed at or above the highest point of a structure such all parts of a roof may be soaked by soaker component 214. On a structure with a split roof, soaker components 214 may be distributed to cover different sides of the split roof evenly.

The distribution conduit 212 can be any suitable conduit, piping or tubing. In one example, the distribution conduit can be ¾ inch diameter pipe. In some examples, the distribution conduit 212 can be plastic or PVC pipe. In other examples, galvanized or other metal piping can be used. In some examples, the conduits of the fire mitigation apparatus 200 can be plastic or PVC for those portions of the conduit that are located underground. For those lengths of conduit located above ground, the conduits can be galvanized pipe or other metal. Such an arrangement can be desirable in certain circumstance to prevent premature failure of the fire mitigation apparatus 200 when the apparatus is subjected to increased heat from a fire that may be threatening to ignite the structure 220. The plastic pipe can be less tolerant to increased temperatures and can be protected by being placed underground. The conduits that may be exposed to increased temperatures in the external environment can be made of galvanized pipe or other metal piping. In other examples, the conduits can all be made of plastic of PVC pipe. In such instances, additional shielding can be used to shield the conduit from increased temperatures or the conduits can be placed or position in locations where it can be shielded from increased temperature or from other environmental effects that can damage the conduit.

As previously described, the diverter valve 108 can also be operated in a second position in which water is guided to the connection point 218. The connection point 218 can be a connector, fitting or other extension that can allow an external device to be connected to the connection point 218. In one example, the connection point is a threaded female or male connector that can be fluidly connected to an external fire mitigation device, e.g., a fire hose. In the event that firefighter is located at or near the structure 220 and need additional water to protect the structure 220 from fire, the diverter valve 108 can be moved to the second position and a fire hose can be connected to the connection point 218. The pump 106 can then be used to pump/transport water from the swimming pool 202 and out of the fire hose and used by the firefighter. In other examples, the connection point 218 can include other quick connect or other threaded fittings or the like to allow other devices to be connected to the fire mitigation apparatus 200 such as, garden hoses, irrigation systems, firefighting equipment and the like.

As further shown in FIG. 2, the fire mitigation apparatus 200 can also include a housing 216. The housing 216 can include walls and a cover that can enclose one or more elements of the fire mitigation apparatus 200. In this example, the check valve 104, the pump 106 and the diverter valve 108 are enclosed in the housing 216. The housing 216 can be made of a suitable material to protect the fire mitigation apparatus 200 from environmental contaminants and from elevated temperatures that the elements of the fire mitigation apparatus 200 can be exposed to in the event of a fire. In some examples, the housing 216 can be made from a thin gauge metal coated with a suitable rust inhibitor and/or paint. In other examples, the housing 216 can be made of other materials. In still other examples, the housing 216 can be recessed into the ground to provide further protections to the elements of the fire mitigation apparatus 200. In further examples, the housing 216 may include an inlet port for intake conduit 206. Intake conduit 206 may include multiple components, i.e., one conduit from drain 204 to the inlet port and another conduit from the inlet port to check valve 104 and/or pump 106.

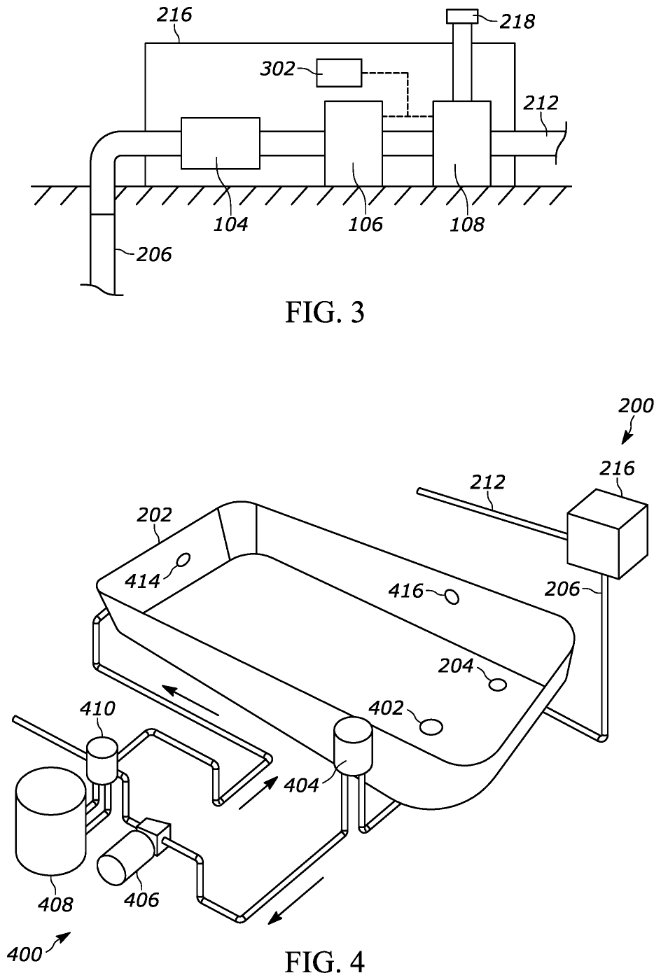

As shown in FIG. 3, the fire mitigation apparatus 200 can also include a mitigation controller 302. The mitigation controller can have the characteristics of the mitigation controller 112 previously described. In this example, the mitigation controller 112 can be located in the housing 216 and can be operably coupled to the pump 106 and/or to the diverter valve 108 to allow activation and/or control of the pump 106 and/or to the diverter valve 108.

Turning now to FIG. 4, the housing 216 of the fire mitigation apparatus 200 is shown in a position adjacent to the swimming pool 202. As shown, the intake conduit 206 can be fluidly connected to the drain 204. The drain 204 can be a drain that is dedicated and independent of other drains or systems of a filtering system 400 that may be operated to filter the water of the swimming pool 202. In the example shown, the filtering system includes a skimmer 404, a filtering pump 406, a filter valve 410, and a filter 408. The filtering system 400 can operate to draw water from the skimmer 404 that is fluidly connected to the filter drain 402. This water can be filtered through the filter 408 and then returned to the swimming pool via the return ports 414, 416. As shown, the filter drain 402, the skimmer 404 and the return ports 414, 416 can draw water from and return water to the swimming pool 202 independently of the fire mitigation apparatus 200.

In addition to showing an example diverter valve, FIG. 5 illustrates an example protection soaker 210. In this example, the protection soaker 210 is fluidly connected downstream of the diverter valve 108. The protection soaker 210 can be fluidly connected to the distribution conduit 212 and can extend away from the distribution conduit 212 with an extension portion 510. A ball valve 512 or other shut-off valve can be positioned between the distribution conduit 212 and the dispenser 514. The ball valve 512 can be used to shut off the flow of water to the dispenser 514. The dispenser 514 can be located at a distal end of the protection soaker 210. The dispenser can be any suitable nozzle, outlet, sprinkler head or the like. In the example shown, the dispenser is sprinkler head. The sprinkler head can distribute water in a distribution zone around the dispenser 514. In some examples, the sprinkler head can be heat activated in that water will not be dispensed from the sprinkler head unless the sprinkler head experiences a rise in temperature that can be indicative of a fire in close proximity. It should be noted that soaker components 110, 214 can have similar structures to that described for the protection soaker 210. The sprinkler components can include ball or other shut-off valves positioned between the distribution conduit 212 and the distal end of each soaker component.

In addition to the fire mitigation apparatuses described above, one or more methods of mitigating the risk of fire to a structure are contemplated. In one example method, the fire mitigation apparatus 200 can be used. The method can begin with the step of activating the pump 106. The pump 106 may be selectively changed from the dormant stand to the active state. The activation of the pump can be performed in any suitable manner including manually in some instances in which the pump includes an manual control. The pump 106 can also be activated using the mitigation controller 112. The mitigation controller 112 can also activate the pump 106 based on data or an instruction sent from a location remote from the fire mitigation apparatus 200. In such examples, the mitigation controller 112 can include a suitable transceiver to allow a user to communicate with the mitigation controller 112 via a communication network such as a local area network, short-range wireless network (e.g., Bluetooth signal), cellular network, satellite network, wired network, Wi-Fi network, the Internet or the like. In still other examples, the mitigation controller 112 can automatically activate the pump 106 when the mitigation controller receives an activation signal from a sensor that may detect a localized or approaching fire or from an emergency response system or from other emergency provider or local governmental authority. As can be appreciated, the activation of the pump 106 can pressurize the water system of the fire mitigation apparatus 200 and cause water to pump from the swimming pool 202 to a desired dispensing component.

The method can continue by selecting a position of the diverter valve 108. The position (or setting) of the diverter valve 108 can determine the direction to which the water will be dispensed in the fire mitigation apparatus 200. In apparatuses with a 3-way valve like that shown in the example of FIG. 2, a first position or second position can be selected on the diverter valve 108. In some examples, the position of the diverter valve 108 can be manually selected using the selector handle 502 (FIG. 5). In other examples, the position of the diverter valve 108 can be controlled by the mitigation controller 112. The mitigation controller 112 can, in some examples, allow the remote control of the diverter valve 108. The diverter valve 108 can allow the operation of the fire mitigating system in a firefighting mode and in a soaking mode. In the firefighting mode, the diverter valve 108 can be positioned to guide water to the connection point 218. A fire hose can be connected to the connection point 218 to allow active firefighting to be performed using the water from the swimming pool as the water source. In the soaking mode, the diverter valve 108 can be positioned to guide water to the one or more soaker components 210, 214 that can be positioned at or around the structure 220. In the soaker mode, the water from the swimming pool can be dispensed from one or more nozzles or sprinkler heads to soak the structure with water in the effort to prevent or reduce the risk of fire damage to the structure.

In some examples, diverter valve 108 can be positioned in a dual mode that guides water to both to the connection point 218 and to the one or more soaker components 210, 214 that can be positioned at or around the structure 220. Diverter valve 108 may include variable valve where a varying amount (between 0 and 100%) of the water is diverted to each of connection point 218 and soaker components 210, 214. In one example, diverter valve 108 may allow both soaking and firefighting functions to work at the same time upon the firefighter (or other user) choosing the water pressure to be divided between the two positions. A handle on diverter valve 108 pointing more to the direction of soaker will make the water volume more powerful to the sprinklers and the handle pointing more in the direction of the fire hose will allow stronger pressure to the fire hose.

The method can continue with the step of dispensing water from the swimming pool to one or more dispensing points. In this step, pump 106 is activated to deliver pool water to diverter valve 108. In the firefighting mode, the water is dispensed from the connection point 218. In the soaking mode, the water is dispensed from the one or more soaker components 214.

The fire mitigation apparatus 200 can be installed when a new pool is installed at or near a structure such as at a residential home. The fire mitigation apparatus 200 can also be retrofit to operate with a pool that may already have been installed. The present disclosure contemplates a method of retrofitting an installed swimming pool and residence with the fire mitigation apparatus. The method can begin with the step of excavating the ground adjacent to a portion of the swimming pool and installing a drain at or near a base of the pool. In other examples, the drain can be installed in a side wall of the pool. An intake conduit can be fluidly connected to the drain and buried in the ground when the excavated earth is replaced around the swimming pool. The check valve 104, the pump 106 and the diverter valve can be installed and fluidly connected to the intake conduit. The distribution conduit and the soaker components can be installed at predetermined locations on the residence to provide a distribution pattern to soak the home in case of fire or risk of fire. The fire mitigation apparatus can then be operated as previously described. It is also understood that the fire mitigation apparatus 200 can comprise a separate plumbing system connected to an existing pool drain.

The fire mitigation apparatus and the methods described herein are improvements over existing fire mitigation systems and methods. The fire mitigation apparatus and methods can allow the valuable water resource that currently exists near many homes to be used in extreme circumstances to aid in reducing the risk of fire to the home or other structure. Swimming pools are often found in environments that have warmer temperatures and can have increased risk level of fire. The apparatuses and methods of the present disclosure make an entertainment or pleasure asset (i.e., a swimming pool) and convert the asset into a risk mitigation asset. The apparatuses and methods of the present disclosure not only allow a homeowner to soak or dispense water on their home when needed but also allows firefighters to quickly and easily dispense water from a swimming pool using only a fire hose. This can free valuable firefighting resources to be used in other locations. In some embodiments, mitigation controller 112 accepts a service key to unlock a firefighting mode which allows access to activate/deactivate pump 106 and/or diverter valve 108. Firefighters may have access to the service key (either provided after installation, or they have a master/generic key operable to control multiple different mitigation controllers) to activate the fire mitigation apparatus in the event of a fire.

The example methods and apparatuses described herein may be at least partially embodied in the form of computer-implemented processes and apparatus for practicing those processes and/or the described functionality. The disclosed methods may also be at least partially embodied in the form of tangible, non-transient machine readable storage media including computer program code. The media may include, for example, RAMs, ROMs, CD-ROMs, DVD-ROMs, BD-ROMs, hard disk drives, flash memories, or any other non-transient machine-readable storage medium, or any combination of these mediums, wherein, when the computer program code is loaded into and executed by a computer, the computer becomes an apparatus for practicing the method. The methods may also be at least partially embodied in the form of a computer into which computer program code is loaded and/or executed, such that, the computer becomes an apparatus for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An apparatus for mitigating a risk of fire comprising:
an intake conduit configured to receive a volume of water;
a pump coupled to the intake conduit, the pump configured to transport the volume of water to one of a soaker component connection and a connection point configured to connect to an external fire mitigation device;
a diverter valve coupled to the pump, the diverter valve selectively operable in a first position and in a second position, where the first position fluidly connects the intake conduit to the soaker component connection and the second position fluidly connects the intake conduit to the connection point; and
a controller configured to accept a service key to unlock access to the pump or the diverter valve.

2. The apparatus of claim 1, where the connection point comprises a fitting configured to couple to a fire hose.

3. The apparatus of claim 1, where the diverter valve comprises a selector handle, the selector handle configured to move the diverter valve from the first position to the second position.

4. The apparatus of claim 1 further comprising a check valve fluidly connected between the intake conduit and the pump.

5. The apparatus of claim 1 further comprising a protection soaker comprising a heat-activated sprinkler head, the protection soaker fluidly connected to the pump and configured to dispense the volume of water onto at least one of the pump and the diverter.

6. The apparatus of claim 1 further comprising a mitigation controller, the mitigation controller operatively connected to the pump to selectively change the pump from a dormant state to an active state.

7. The apparatus of claim 6 further comprising a housing, the housing substantially enclosing the pump, the diverter valve and the mitigation controller.

8. The apparatus of claim 6, where the mitigation controller is connected to a communication network to allow the pump to be selectively changed from the dormant state to the active state from a location remote from the mitigation controller.

9. The apparatus of claim 6, where the mitigation controller comprises:
a processing device; and
a non-transient machine readable storage media comprising computer program code which, when executed by the processing device, causes the mitigation controller to:
receive information about the risk of fire; and
in response to receiving the information, activate the pump.

10. The apparatus of claim 9, wherein the information about the risk of fire is received from at least one of: a local user selection, a remote user selection, a weather information source, an emergency management information source, and sensor data.

11. The apparatus of claim 1 further comprising a back-up power source, where the pump is operatively connectable to the back-up power source.

12.-20. (canceled)

21. The apparatus of claim 1 further comprising:
a drain fluidly coupled to a base of a swimming pool, the drain coupled to the intake conduit.

22. The apparatus of claim 1 where the intake conduit is couplable to a swimming pool comprising the volume of water.

23. The apparatus of claim 1 where the intake conduit is coupled to a drain of a pool comprising the volume of water, and where the pump is configured to transport the volume of water received from the pool to the one of the soaker component connection and the connection point to mitigate the risk of fire to a structure.
